(19) United States
(12) Patent Application Publication
(10) Pub. No.: US 2016/0207133 A1
(43) Pub. Date: Jul. 21, 2016

(54) Method of Manufacturing Small-Diameter Stainless Pipe

(71) Applicant: WOOSEOK STS CO.,LTD., Busan (KR)

(72) Inventor: Mitchell Victor KANG, Busan (KR)

(73) Assignee: WOOSEOK STS CO., LTD., Busan (KR)

(21) Appl. No.: 14/895,453

(22) PCT Filed: Jul. 20, 2015
(86) PCT No.: PCT/KR2015/007485

§ 371 Date: Dec. 2, 2015

(30) Foreign Application Priority Data
Jul. 21, 2014 (KR) 10-2014-0091753

(51) Int. Cl. B23K 9/025; B23K 9/16; B21C 37/08

(52) U.S. Cl. CPC B23K 9/0253; B21C 37/08; B23K 9/16

(57) ABSTRACT

A method of manufacturing a stainless pipe is provided. The method includes gradually curving the stainless pipe into a ring type, plasma-welding opposite ends of the curved stainless pipe so that back beads are formed, additionally TIG-welding the plasma-welded part to form bead mountings, externally applying pressure force onto an outer portion of the stainless pipe while inserting a mandrel into the welded stainless pipe such that the mandrel comes into contact with the back beads, thereby flattening the back beads, removing the bead mountains, setting an outer diameter of the stainless pipe, RF heat-treating the welded part, cooling the welded part, and a second sizing stage.

### BACKGROUND OF THE INVENTION

1. Field of the Invention

The present invention relates generally to a method of manufacturing a small-diameter stainless pipe and, more particularly, to a method of manufacturing a small-diameter stainless pipe at high speed without back beads and bead mountains, using welding.

2. Description of Related Art

Generally, stainless pipes in various sizes have been manufactured in a seamless welding manner.

When stainless pipes are manufactured with welding, bead mountains and back beads may be essentially formed and should be smoothened and finished. Further, manufacturing speed is directly connected to the price of a product, so increasing the speed of production is desired.

In a conventional method, it takes approximately six minutes to manufacture a 2 mm or more thick, small-diameter (15˜25.4 mm outer diameter) stainless pipe having a length of 6000 mm.

The conventional method may be a mandrel one-touch production method in which a pipe material is curved so that opposite ends thereof are TIG-welded together, while the pipe material is supplied, and back beads and bead mountains are subsequently treated.

The conventional production method using TIG welding has degraded productivity, since it takes much time for TIG welding to form back beads due to low depth of penetration.

As another conventional technique, an apparatus and method for removing weld beads of a pipe using a mandrel, and a pipe manufactured using the same are disclosed in Korean Patent No. 10-0531101 (registered on Nov. 18, 2005).

The above technique is performed such that a pipe is fabricated with welding and then weld beads are removed in a separate process. The apparatus includes a hydraulic unit 210, 310, and 410 that is mounted to receive hydraulic pressure from a power unit 600 to fix a pipe 20, a mandrel 800 that is inserted into the pipe 20 to cut weld beads 21, and a water-pressure unit 610, 620, and 630 that is mounted to receive water pressure from the power unit 600 to allow the mandrel 800 to be applied with cutting water with test water pressure so that the mandrel 800 is forcedly inserted into the pipe 20, wherein weld beads 21 and bead chips are removed and an internal pressure test is performed at the same time, while the mandrel 800 is forcedly pushed with the cutting water along an inner diameter part of the pipe 20.

Although the above technique has an advantage that the internal pressure test is simultaneously performed on the manufactured pipe, the pipe is first manufactured and then weld beads are removed in an additional process, resulting in poor productivity.

### SUMMARY OF THE INVENTION

Technical Problem: Accordingly, the present invention has been made keeping in mind the above problems occurring in the related art, and the present invention is intended to propose a method of manufacturing a stainless small-diameter pipe in line, thereby obtaining higher productivity over the conventional method.

Technical Solution: In order to achieve the above object, according to one aspect of the present invention, there is provided a method of manufacturing a stainless pipe having an outer diameter of 15 mm˜25.4 mm and a thickness of 2 mm˜3 mm, the method including: a forming stage of gradually curving the stainless pipe into a ring type; a first welding stage of plasma-welding opposite ends of the curved stainless pipe so that back beads are formed; a second welding stage of additionally TIG-welding the plasma-welded part to form bead mountings; a back bead-treating stage of externally applying pressure force onto an outer portion of the stainless pipe while inserting a mandrel into the welded stainless pipe such that the mandrel comes into contact with the back beads, thereby flattening the back beads; a bead mountain-polishing stage of removing the bead mountains; a first sizing stage of setting an outer diameter of the stainless pipe; and a stage of RF heat-treating the welded part; a stage of cooling the welded part; and a second sizing stage.

The first welding stage may be plasma-welding with narrow width and deep depth of penetration to allow the back beads to be formed.

The second welding stage may be TIG-welding with wide width and low depth of penetration to allow the bead mountains to be formed in a convex form.

Advantageous Effects: According to the manufacturing method of the small-diameter stainless pipe, the stainless pipe is formed by plasma-welding followed by the TIG-welding, which has an effect of improving production speed by three times or more.

Further, according to the present invention, the stainless pipe is formed by successively inline welding, back bead-treatment using the mandrel, and bead mountain-flattening using polishing, thereby reducing quality degradation of a product and obtaining improved appearance and product value accordingly.

### BRIEF DESCRIPTION OF THE DRAWINGS

FIG. 1 is a processing view illustrating a method of manufacturing a small-diameter stainless pipe according to the present invention.

FIG. 2 is a cross-sectional view of the stainless pipe after first and second welding stages.

FIG. 3 illustrates major processes of the present invention.

### DESCRIPTION OF SIGNS

S1: forming stage

S2: first welding stage

S3: second welding stage

S4: back bead-treating stage

S5: bead mountain-polishing stage

S6: first sizing stage

S7: RF heat-treatment stage

S8: cooling stage

S9: second sizing stage

10: back bead

20: bead mountain

30: mandrel

40: press roller

### DETAILED DESCRIPTION OF THE PREFERRED EMBODIMENTS

Herein below, preferred embodiments of the present invention will be described in detail with reference to the accompanying drawings.

The present invention is directed to a method of manufacturing a small-diameter stainless pipe having an outer diameter of 15 mm˜24.5 mm and a thickness of 2 mm˜3 mm. The method includes a forming stage (S1), a first welding stage (S2), a second welding stage (S3), a back bead-treating stage (S4), a bead mountain-polishing stage (S5), a first sizing stage (S6), an RF heat-treatment stage (S7), a cooling stage (S8), and a second sizing stage (S9).

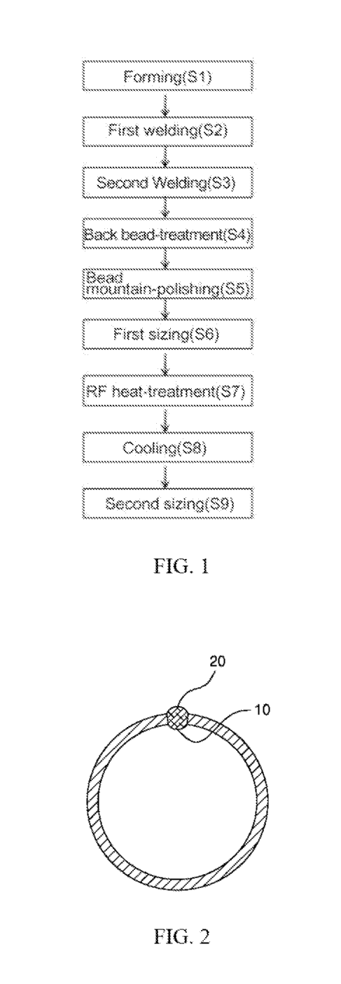

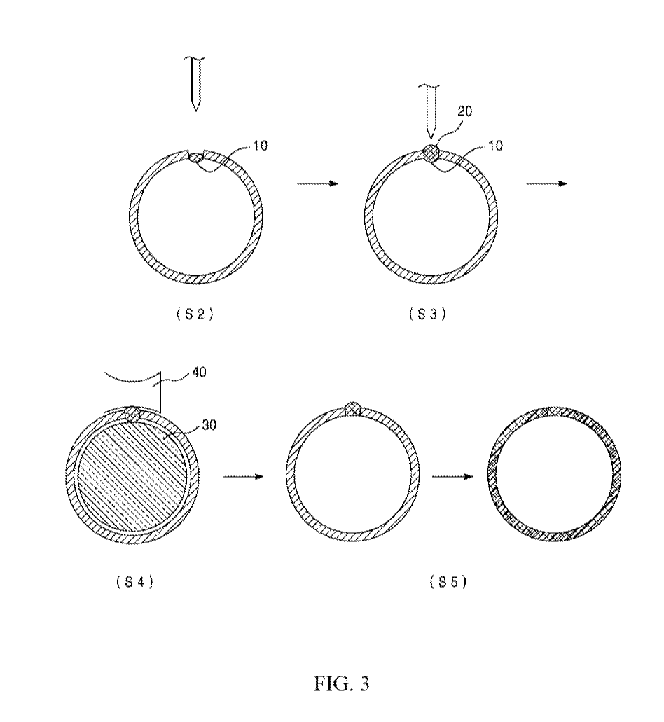

FIG. 1 is a processing view illustrating a method of manufacturing a small-diameter stainless pipe according to the present invention, FIG. 2 is a cross-sectional view of the stainless pipe after first and second welding stages, and FIG. 3 illustrates major processes of the present invention.

In the forming stage (S1), a stainless pipe wound around an uncoiler is curved into a ring-type while being supplied.

Next, in the first welding stage (S2), opposite ends of the curved stainless pipe are welded together. Particularly, the welding is plasma-welding with which back beads 10 can be formed.

The plasma welding is characterized by deep depth and narrow width of penetration, so, when the plasma welding is performed on the opposite ends that were abutted, the back beads 10 are formed on an inner surface of the stainless pipe during welding. The plasma welding has an advantage of obtaining rapid welding speed and uniform welds.

After the first welding stage (S2), the second welding stage (S3) is performed.

The second welding stage (S3) is TIG welding that is characterized by lower depth and wider width of penetration relative to the plasma welding. Thus, the TIG welding is additionally performed on the plasma-welding part that was first formed, so that convex bead mountains 20 are formed.

Like this, the present invention performs welding, which affects quality and workability in manufacturing the stainless pipe, by the first and second welding stages (S2 and S3) that will be continuously performed, thereby facilitating good welding while effectively and quickly forming the back beads 10 and bead mountains 20.

Next, the back bead-treatment stage (S4) is performed. The back beads 10 that were formed on the inner surface of the stainless pipe in a convex form are applied with appropriate pressure force, thereby being flattened. Here, a mandrel 30 is used to treat the back beads 10 in such a manner that the mandrel 30 is inserted into the welded stainless pipe so that the mandrel 30 comes into contact with the back beads 10, and at the same time, the bead mountains 20 are externally pressurized from the outer surface of the stainless pipe by a press roller 40 to allow the welded part to be applied with a compressive force.

That is, the compressive force is applied to the welded part, i.e. the back beads 10 and the bead mountains 20, simultaneously from upward and downward directions, so that the back beads 10 are deformed in a flattened form. Of course, bead mountains 20 are also compressed and flattened to an extent.

Like this, when the compressive force is applied to the welded part including the back beads 10 and the bead mountains 20, voids contained in the welded part (that occur during welding) may also be removed, thereby generally reducing welding defects and thus improving welding quality.

Next, the bead mountain-polishing stage (S5) is performed. In the stage (S5), the bead mountains 20 formed on the outer surface of the stainless pipe are polished to form a smooth outer surface of the welded part. When the formed stainless pipe passes through a polishing unit, the bead mountains are polished into a smooth surface, thereby obtaining an appearance like a seamless pipe.

After the bead mountain-polishing stage (S5), the first sizing stage (S6) is performed so that the stainless pipe is formed to have a standard outer diameter size.

Next, the RF heat-treatment stage (S7) is performed on the welded part so that the welded part is annealed to prevent the structure thereof from being easily damaged, and then the cooling stage (S8) is performed.

In the cooling stage (S8), the first cooling is performed in an H₂ or N₂ gas atmosphere and the second cooling is continuously performed using water.

After the cooling stage (S8), the second sizing stage (S9) is performed to set the outer diameter size more precisely.

After the second sizing stage (S9), the stainless pipe being carried is cut to a predefined length, and is wrapped.

As set forth in the foregoing, the present invention provides a high-quality small-diameter stainless pipe in rapid speed and improved productivity through an inline manner.

According to the present invention, it is applicable to a method of manufacturing a high-quality small-diameter stainless pipe in improved productivity.

Industrial Applicability: Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A method of manufacturing a stainless pipe having a thickness of 2 mm˜3 mm and an outer diameter of 15 mm˜25.4 mm, the method comprising:
a forming stage of gradually curving the stainless pipe into a ring type;
a first welding stage of plasma-welding opposite ends of the curved stainless pipe so that back beads are formed;
a second welding stage of additionally TIG-welding the plasma-welded part to form bead mountings;
a back bead-treating stage of externally applying pressure force onto an outer portion of the stainless pipe while inserting a mandrel into the welded stainless pipe such that the mandrel comes into contact with the back beads, thereby flattening the back beads;
a bead mountain-polishing stage of removing the bead mountains;
a first sizing stage of setting an outer diameter of the stainless pipe;
a stage of RF heat-treating the welded part;
a stage of cooling the welded part; and
a second sizing stage.

2. The method according to claim 1, wherein the first welding stage is plasma-welding with narrow width and deep depth of penetration to allow the back beads to be formed.

3. The method according to claim 2, wherein the second welding stage is TIG-welding with wide width and low depth of penetration to allow the bead mountains to be formed in a convex form.
